(19) United States
(12) Patent Application Publication
(10) Pub. No.: US 2018/0240179 A1
(43) Pub. Date: Aug. 23, 2018

(54) INFORMATION PROCESSING APPARATUS, INFORMATION PROCESSING METHOD, AND CONSUMABLE ITEM ORDERING SYSTEM

(71) Applicant: CANON KABUSHIKI KAISHA, Tokyo (JP)

(72) Inventor: Hiroyuki Yamamoto, Kawasaki-shi (JP)

(21) Appl. No.: 15/895,810

(22) Filed: Feb. 13, 2018

(30) Foreign Application Priority Data
Feb. 20, 2017 (JP) 2017-029400

(51) Int. Cl. G06Q 30/06; B41J 2/175; B41J 29/393

(52) U.S. Cl. CPC G06Q 30/0633; B41J 29/393; B41J 2/17509; B41J 2/17566

(57) ABSTRACT

In a consumable item ordering system, it is possible to prevent a double order for a consumable item not intended by a user. An information processing apparatus includes: a reception unit configured to receive consumable item information indicating a remaining amount of a consumable item attached to an image processing apparatus; and an ordering unit configured to make an order for the consumable item on a condition that the remaining amount of the consumable item indicated by the consumable item information received by the reception unit is smaller than or equal to a predetermined threshold value, and the ordering unit does not make an order for the consumable item in a case where another condition in relation to second consumable item information received by the reception unit prior to first consumable item information is satisfied, even though the remaining amount of the consumable item indicated by the first consumable item information received by the reception unit is smaller than or equal to the predetermined threshold value.

### BACKGROUND OF THE INVENTION

### Field of the Invention

The present invention relates to a system that automatically makes an order for a consumable item attached to an image processing apparatus.

### Description of the Related Art

An image processing apparatus represented by a printer, a copy machine, and a facsimile requires consumable items, such as ink, toner, and sheets. In the case where a consumable item required by an image processing apparatus runs out or runs short, a user him/herself goes to a shop and purchases the consumable item.

In recent years, an image processing apparatus has appeared, which is capable of communication with a WEB server by connecting to the Internet. For example, a consumable item ordering system has appeared in which an image processing apparatus notifies a WEB server of information on the remaining amount of a consumable item and the WEB server makes an order for the consumable item with a shop based on the information on the remaining amount of the consumable item (see Japanese Patent Laid-Open No. 2001-297237). According to the system described in Japanese Patent Laid-Open No. 2001-297237, such trouble that a consumable item is short at the time of a user intending to use an image processing apparatus is solved.

However, in the consumable item automatic ordering system as described in Japanese Patent Laid-Open No. 2001-297237, it is demanded to suppress an order for a consumable item that is not intended by a user from being made. For example, it is demanded to prevent a double order from being made despite that an order for the consumable item has already been made.

The present invention has been made in view of the above-described problem and an object is to provide an information processing apparatus, an information processing method, and a consumable item ordering system, which are capable of suppressing an order for a consumable item not intended by a user.

### SUMMARY OF THE INVENTION

An information processing apparatus according to the present invention includes: a reception unit configured to receive consumable item information indicating a remaining amount of a consumable item attached to an image processing apparatus; and an ordering unit configured to make an order for the consumable item on a condition that the remaining amount of the consumable item indicated by the consumable item information received by the reception unit is smaller than or equal to a predetermined threshold value, and the ordering unit does not make an order for the consumable item in a case where another condition in relation to second consumable item information received by the reception unit prior to first consumable item information is satisfied, even though the remaining amount of the consumable item indicated by the first consumable item information received by the reception unit is smaller than or equal to the predetermined threshold value.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a consumable item ordering system according to a first embodiment;

FIG. 2 is a block diagram showing an example of an internal configuration of an MFP;

FIG. 3 is a block diagram showing an example of an internal configuration of a management server;

FIGS. 4A and 4B are diagrams for explaining a function configuration of the management server;

FIG. 5 is a flowchart showing a flow of processing of the MFP to transmit consumable item information to the management server;

FIG. 6 is a flowchart showing a flow of processing in the first embodiment at the time of the management server making an order for a consumable item with a shop based on consumable item information received from the MFP;

FIG. 7 is a flowchart showing a flow of processing at the time of the management server receiving a notification of response to an order for a consumable item from a shop;

FIG. 8 is a flowchart showing a flow of processing in a second embodiment at the time of the management server making an order for a consumable item with a shop based on consumable item information received from the MFP;

FIG. 9 is a flowchart showing a flow of processing at the time of the management server receiving a user ordering request for a consumable item from a user in a third embodiment;

FIG. 10 is flowchart showing a flow of processing in the third embodiment at the time of the management server making an order for a consumable item based on consumable item information received from the MFP;

FIG. 11 is a flowchart showing a flow of processing at the time of the management server receiving a consumable item already purchased notification from a user in a fourth embodiment; and

FIG. 12 is a flowchart showing a flow of processing of the fourth embodiment at the time of the management server making an order for a consumable item with a shop based on consumable item information received from the MFP.

### DESCRIPTION OF THE EMBODIMENTS

In the following, preferred embodiments of the present invention are explained in detail with reference to the attached drawings.

### First Embodiment

First, a configuration of a consumable item ordering system according to a first embodiment is explained.

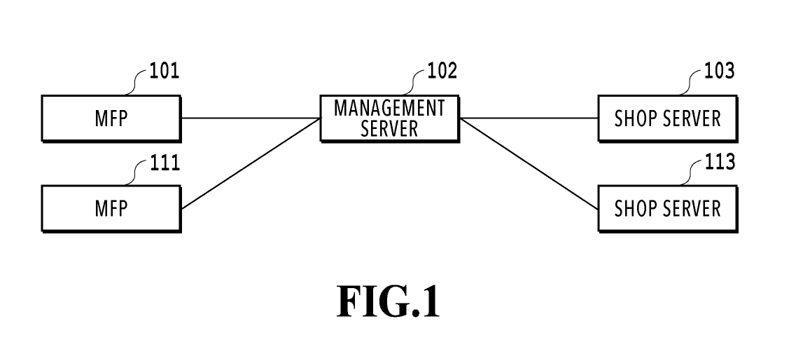

FIG. 1 is a block diagram showing an example of a configuration of the consumable item ordering system according to the first embodiment. The consumable item ordering system according to the first embodiment is a client-server network system. The consumable item ordering system shown in FIG. 1 includes image processing apparatuses 101 and 111, an information processing apparatus (hereinafter, also called a management server) 102, and shop terminals (hereinafter, also called shop servers) 103 and 113.

The image processing apparatuses 101 and 111 are multi function printers (hereinafter, MFPs). Each of the MFPs 101 and 111 is connected with the management server 102 via the Internet. Further, each of the shop servers 103 and 113 is connected with the management server 102 via the Internet. In the present embodiment, as a peripheral device of the management server 102, the MFP is taken as an example, but to the management server 102, a copy machine, a facsimile, and so on, may be connected. Further, the shop servers 103 and 113 are only required to be capable of communicating with the management server 102 by HTTPS, and not limited to a server. In FIG. 1, the two MFPs are illustrated, but to the management server 102, any number of MFPs may be connected. Further, in FIG. 1, the two shop servers are illustrated, but to the management server 102, any number of shop serves may be connected. Furthermore, the consumable item ordering system may include any number of management servers.

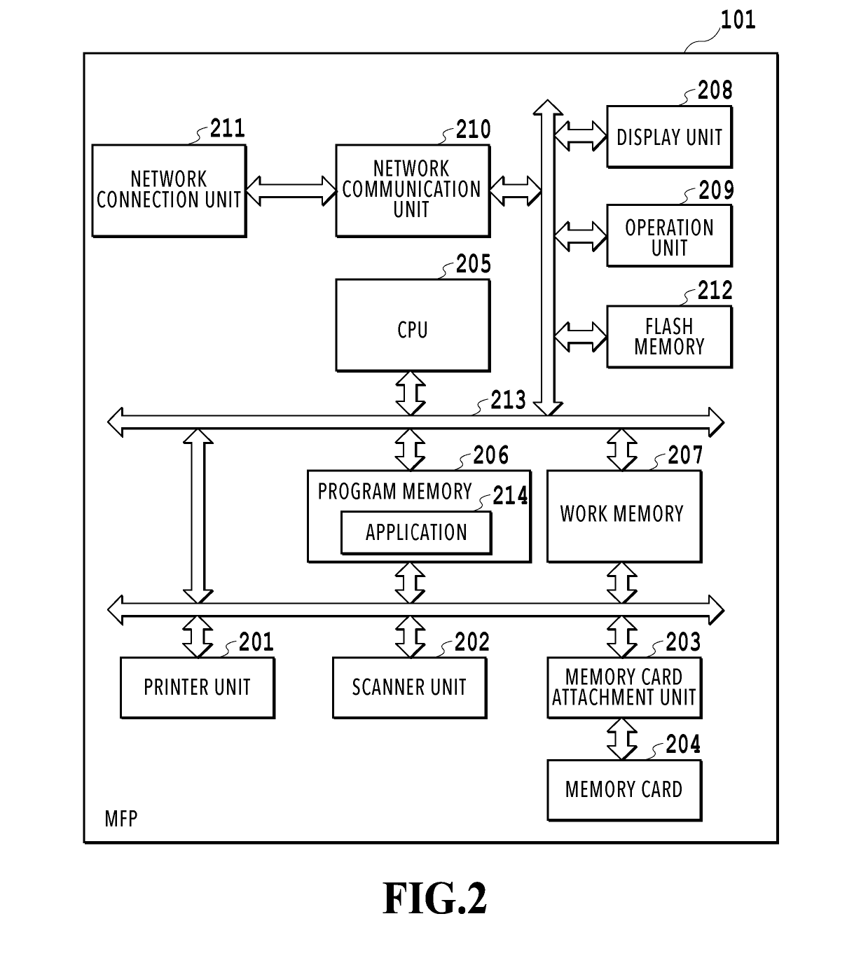

FIG. 2 is a block diagram showing an example of an internal configuration of the MFP 101. The configuration of the MFP 111 is the same as that of the MFP 101, and therefore, explanation is omitted.

The MFP 101 includes a printer unit 201, a scanner unit 202, and a memory card attachment unit 203.

In the MFP 101, the printer function is implemented by the printer unit 201, the scanner function is implemented by the scanner unit 202, and the storage function is implemented by the memory card attachment unit 203 and a memory card 204.

The printer unit 201 prints image data received from outside, image data stored in the memory card 204, and so on, on a printing medium (for example, a sheet) by a printing method, such as an ink jet method and an electrophotographic method. Further, the printer unit 201 manages ink information including an ink remaining amount and sheet information including a number of loaded sheets.

The scanner unit 202 optically reads a document that is set on a document table (not shown schematically) and converts into electronic data. Further, the scanner unit 202 generates image data by converting the electronic data into a specified file format and transmits the generated image data to an external device via a network, stores the image data in a saving area (not shown schematically), such as an HDD, and so on. The copy service is implemented by the scanner unit 202 reading a document placed on a document table and generating image data, and by the printer unit 201 printing the generated image data on a printing medium.

In the memory card 204 attached to the memory card attachment unit 203, various pieces of file data are stored. It is possible to read and edit file data stored in the memory card 204 from an external device via a network. Further, it is also possible to store file data in the memory card 204 from an external device.

The MFP 101 further includes a CPU 205, a program memory 206, a work memory 207, a display unit 208, an operation unit 209, a network communication unit 210, a network connection unit 211, and a flash memory 212. The CPU 205 is a central processing unit configured to control each component within the MFP 101. The program 206 is a ROM and the like and stores various program codes and an application 214 to communicate with a server device. The application 214 acquires consumable item information on ink, sheets, and so on, by accessing the printer unit 201. The work memory 207 is a RAM and the like and temporarily stores image data and the like at the time of performing each service, performs buffering, and so on. The display unit 208 is, for example, an LCD and displays various pieces of information. The operation unit 209 includes a switch and the like for a user to perform various input operations. The network communication unit 210 connects the MFP 101 to a network, such as the Internet. Then, the network communication unit 210 performs various kinds of communication with an external device, such as the management server 102, connected to a network. It is possible for the network communication unit 210 to connect to a network via the network connection unit 211. The network communication unit 210 is compatible with a wired LAN and a wireless LAN. In the case where the network communication unit 210 is compatible with a wired LAN, the network connection unit 211 is a connector to connect a cable of the wired LAN. Further, in the case where the network communication unit 210 is compatible with a wireless LAN, the network connection unit 211 is an antenna. The flash memory 212 is a nonvolatile memory to store image data and the like received by the network communication unit 210. Each of the above-described components is connected to one another by a bus 213.

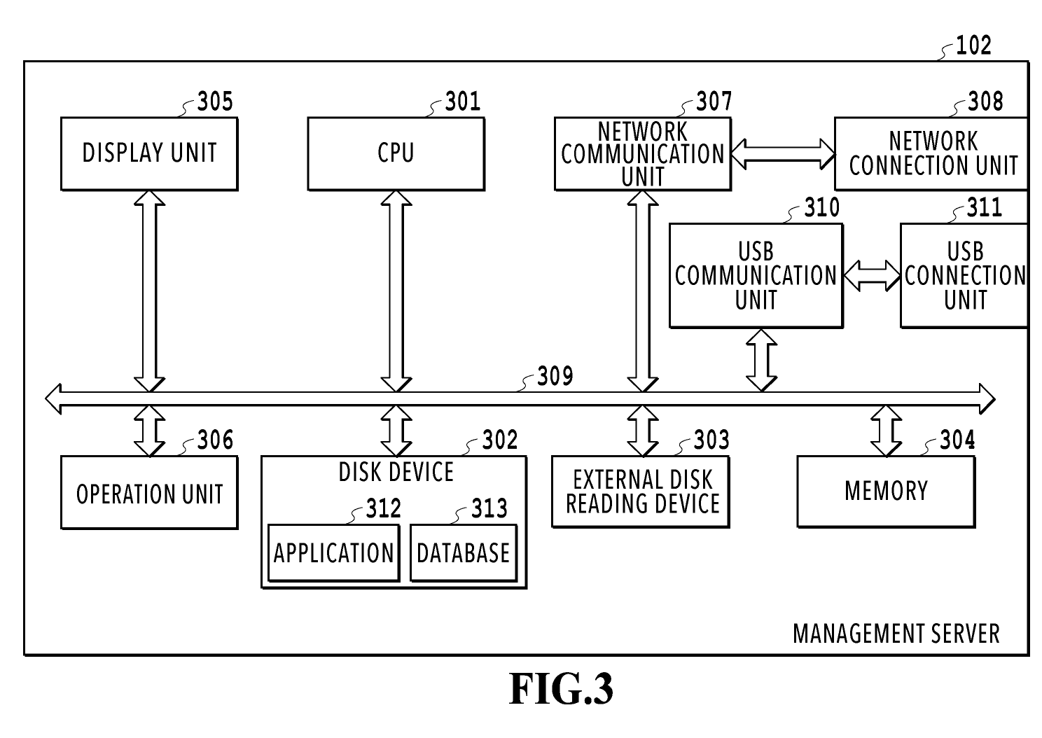

FIG. 3 is a block diagram showing an example of an internal configuration of the management server 102. The shop servers 103 and 113 are also information processing apparatuses like the management server 102 and include the same configuration as that shown in FIG. 3. A CPU 301 is a central processing unit configured to control each component below. A disk device 302 stores an application program (hereinafter, simply called an application) 312 that is read and executed by the CPU 301 and a database (DB) 313. The database 313 stores ordering status information indicating an ordering status (ordering situation) of each consumable item. The disk device 302 stores various files, in addition to an operating system (OS). An external disk reading device 303 is a device to read information, such as files stored in an external storage medium, such as an SD card. A memory 304 is a RAM and the like and the CPU 301 temporarily stores data, performs buffering, and so on, as needed. A display unit 305 is, for example, an LCD and displays various pieces of information. An operation unit 306 is a keyboard, a mouse, and so on, for a user to perform various input operations. A network communication unit 307 is connected with a network, such as the Internet, via a network connection unit 308 and performs various kinds of communication. The network communication unit 307 is compatible with a wired LAN and a wireless LAN. In the case where the network communication unit 307 is compatible with a wired LAN, the network connection unit 308 is a connector to connect a cable of the wired LAN. In the case where the network communication unit 307 is compatible with a wireless LAN, the network connection unit 308 is an antenna. A USB communication unit 310 is connected with various peripheral devices via a USB connection unit 311 and performs communication with the various peripheral devices. Each of the above-described components is connected to one another by a bus 309.

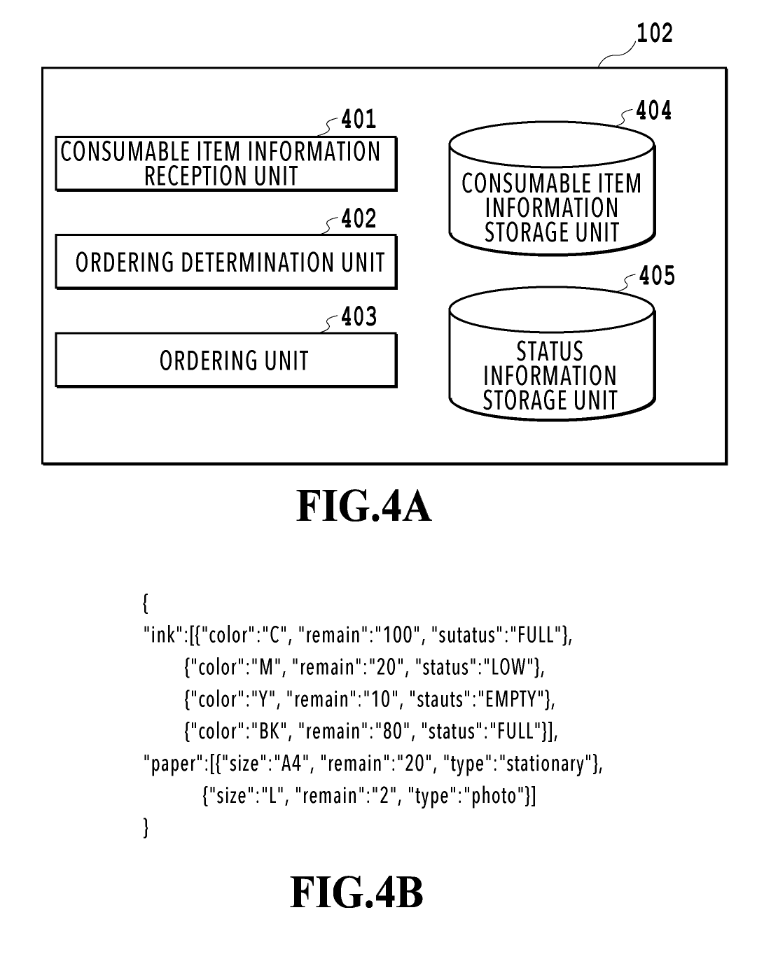

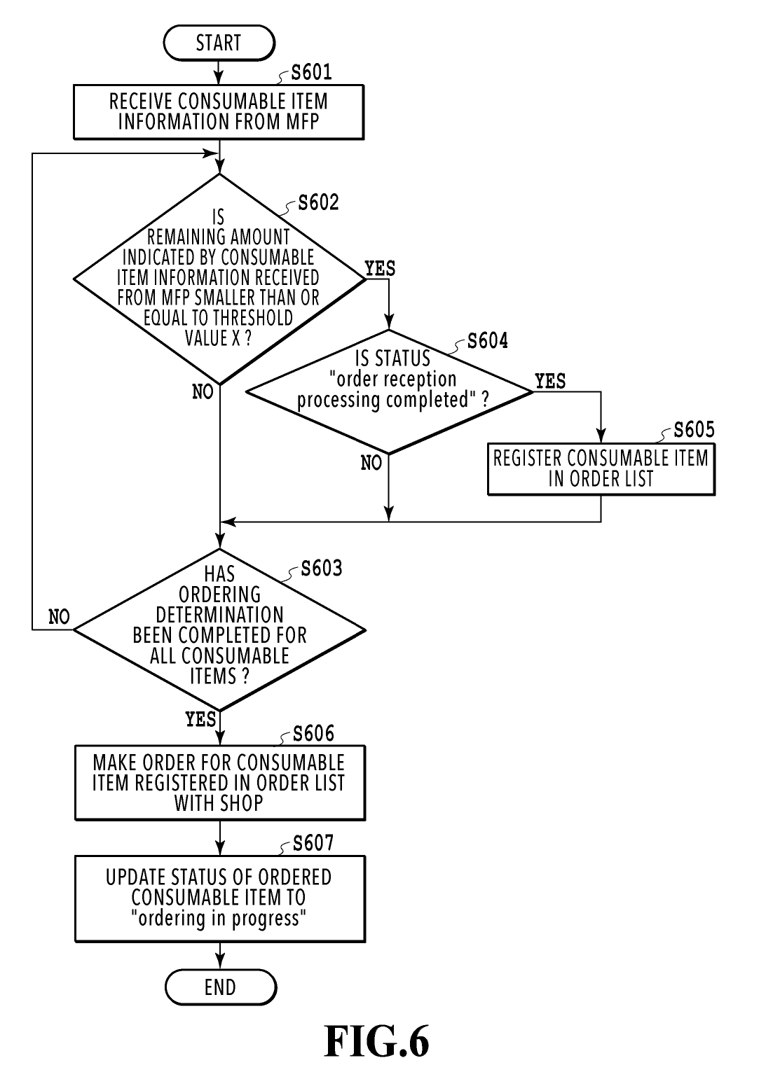

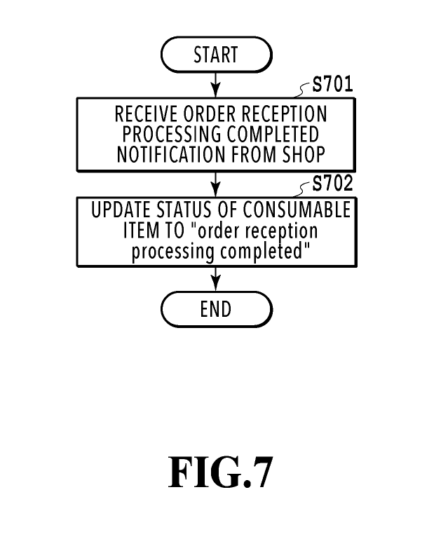

FIGS. 4A and 4B are diagrams for explaining a function configuration of the management server 102. The management server 102 has various functions shown in FIG. 4A. Specifically, the management server 102 has a consumable item information reception unit 401, an ordering determination unit 402, and an ordering unit 403. Each of these functions is implemented by the CPU 301 reading the application 312 stored in the disk device 302 onto the memory 304 and executing the application 312. Due to this, processing shown in FIGS. 6 and 7, to be described later, is performed. Further, the management server 102 has a consumable item information storage unit 404 and a status information storage unit 405. The consumable item information storage unit 404 and the status information storage unit 405 are implemented by the database 313 shown in FIG. 3.

The consumable item information reception unit 401 receives consumable item information transmitted from the MFPs 101 and 111. The consumable item information reception unit 401 stores received consumable item information in the consumable item information storage unit 404. The MFPs 101 and 111 transmit consumable item information by attaching device identification information thereto so that the source of transmission can be specified. Due to this, it is made possible for the management server 102 to specify the MFP, which is the source of transmission of the consumable item information. FIG. 4B shows an example of consumable item information. The consumable item information includes information in relation to a plurality of kinds of consumable item, such as the color, the remaining amount, and the status of each ink and the size, the type, and the number of loaded sheets of the sheet. The consumable item information in the present embodiment includes ink information and sheet information. For example, {“color”: “C”, “remain”: “100”, “status”: “FULL”} in the ink information represents that the remaining amount of C (Cyan) ink is 100 and the status is FULL. Further, for example, {“size”: “L”, “remain”: “2”, “type”: “photo”} in the sheet information represents that the remaining number of photo sheets whose size is L is two. The ordering determination unit 402 determines whether or not to make an order for each consumable item based on the consumable item information stored in the consumable item information storage unit 404. The ordering unit 403 makes an order for a consumable item in accordance with the results of the determination by the ordering determination unit 402. Further, the ordering unit 403 updates the ordering status information stored in the status information storage unit 405 in accordance with the ordering situation of a consumable item. It may also be possible for the ordering unit 403 to perform the determination processing that is performed in the ordering determination unit 402. That is, the ordering determination unit 402 may be included in the ordering unit 403.

Next, in the consumable item ordering system shown in FIG. 1, the processing of the MFPs 101 and 111 to notify the management server 102 of consumable item information and the consumable item ordering processing of the management server 102 having received consumable item information from the MFPs 101 and 111 are explained. The processing of the MFP 101 and the processing of the MFP 111 are the same, and therefore, the processing of the MFP 101 is explained here.

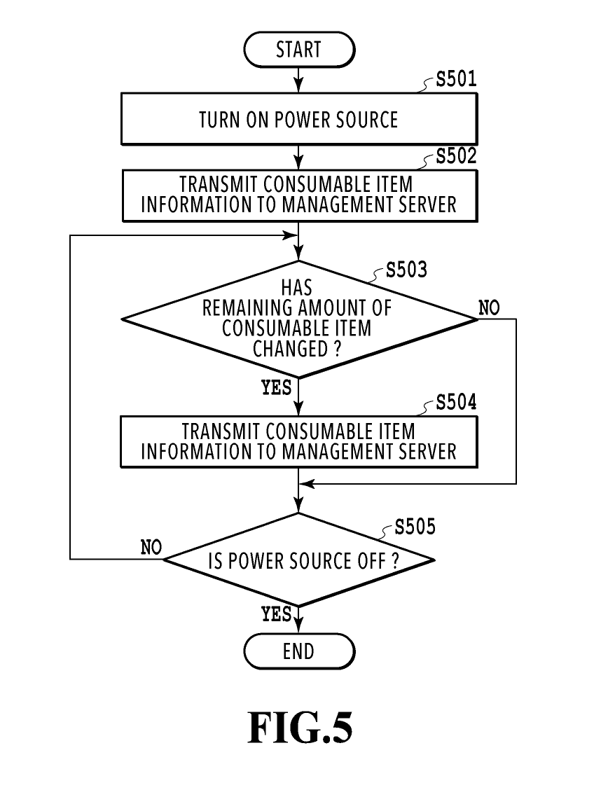

FIG. 5 is a flowchart showing a flow of the processing of the MFP 101 to transmit consumable item information to the management server 102.

In the case where the power source is turned on by a user (step S501), the MFP 101 transmits consumable item information to the management server 102 (step S502). Next, the MFP 101 checks whether the remaining amount of a consumable item attached on the MFP 101 itself has changed (step S503). In the present embodiment, in the case where the remaining amount of a consumable item reaches determination values, such as HALF (50), LOW (20), and EMPTY (0), which are set stepwise, the MFP 101 determines that the remaining amount of a consumable item has changed. It may also be possible to arbitrarily set the values of the above-described determination values and the number of steps in accordance with the kind of a consumable item and the like.

In the case where a consumable item whose remaining amount has changed exists (YES at step S503), the MFP 101 transmits consumable item information to the management server 102 (step S504). In the case where a consumable item whose remaining amount has changed does not exist (NO at step S503), the MFP 101 checks the state of the power source of the MFP 101 itself. Then, in the case where the power source is not OFF (NO at step S505), the MFP 101 returns to the processing at step S503.

Due to this, at the timing of the power source being turned on and at the timing at which the remaining amount of a consumable item changes because printing or copying is performed, consumable item information is transmitted from the MFP 101 to the management server.

FIG. 6 is a flowchart showing a flow of the processing in the first embodiment at the time of the management server 102 making an order for a consumable item with a shop based on consumable item information received from the MFP 101.

The consumable item information reception unit 401 receives consumable item information from the MFP 101 (step S601). Then, the ordering determination unit 402 checks whether the remaining amount of a consumable item indicated by the received consumable item information is smaller than or equal to a threshold value X (step S602). At this time, in the case where information on a plurality of consumable items is included in the consumable item information, the processing (ordering determination) at steps S602 to S605 is performed, respectively, for each consumable item. As the threshold value X, a value (for example, LOW (20)) is set in advance, which indicates that the remaining amount of a consumable item becomes small. The remaining amount of a consumable item being smaller than or equal to the threshold value X at step S602 is one of the conditions of making an order for a consumable item. In the case where the remaining amount of a consumable item is not smaller than or equal to the threshold value X (NO at step S602), the processing advances to step S603. In the case where the remaining amount of a consumable item is smaller than or equal to the threshold value X (YES at step S602), the processing advances to step S604. This means that an order is made in the case where the amount of a consumable item becomes smaller than a predetermined amount.

At step S604, the ordering determination unit 402 refers to the ordering status information stored in the database 313 (specifically, the status information storage unit 405) and checks whether the ordering status of the consumable item is “ordering completed (hereinafter, described as order reception processing completed)”. Due to this, it is possible to check whether the order made the previous time (the immediately previous order of the orders made prior to the timing at which step S604 is performed) is completed, specifically, whether the order reception processing for the order made the previous time is completed. In the present embodiment, it is assumed that to the ordering status, “order reception processing completed” is set as the initial value. In the case where the ordering status is “order reception processing completed” (YES at step S604), the ordering determination unit 402 registers the consumable item in the order list (step S605) and advances to the processing at step S603. In the case where the ordering status is not “order reception processing completed” (NO at step S604), the ordering determination unit 402 advances to the processing at step S603 without performing the processing at step S605 so as to skip the order for the consumable item.

At step S603, the ordering determination unit 402 checks whether the ordering determination has been performed for all the consumable items included in the consumable item information and in the case where there is an unprocessed consumable item, the processing returns to the processing at step S602. In this manner, the ordering determination at steps S602 to S605 is performed for each consumable item.

At step S606, the ordering unit 403 makes an order for the consumable item registered in the order list with a shop. At this time, in the case where no consumable item is registered in the order list, an order by the ordering unit 403 is not made.

At step S607, the ordering unit 403 performs processing to update the ordering status of the ordered consumable item to “ordering in progress” for the database 313.

FIG. 7 is a flowchart showing a flow of the processing at the time of the management server 102 receiving a notification of response to the order for a consumable item (order reception processing completed notification, to be described later) from a shop.

The ordering unit 403 receives a notification indicating that the order reception processing of a consumable item is completed (hereinafter, called an order reception processing completed notification) from a shop (step S701). Then, processing to update the ordering status of a consumable item corresponding to the received order reception processing completed notification to “order reception processing completed” is performed for the database 313 (step S702). Here, the order reception processing refers to processing from reception of an order for a consumable item by a shop until sending of the consumable item.

As above, in the present embodiment, the management server 102 checks not only whether the remaining amount of a consumable item is smaller than or equal to the threshold value but also whether the ordering status of the consumable item is “ordering in progress” (or “order reception processing completed”) and then makes an order for the consumable item. Specifically, in the case where the ordering status of a consumable item is “ordering in progress”, the order for the consumable item is skipped irrespective of the remaining amount of the consumable item. Due to this, it is possible to suppress an order from being made doubly even in the case where the remaining amount of the consumable item becomes further small during the period of time from making an order for the consumable item because the remaining amount of the consumable item becomes smaller than or equal to the threshold value until sending of the consumable item by a shop. Consequently, according to the present embodiment, it is possible to suppress a double order for a consumable item.

A system has been proposed conventionally, which performs control so that a double order is not made by recording ordering information in a consumable cartridge. However, for such a system, it is necessary to provide a mechanism (electric circuit and the like) to cause a consumable cartridge to hold ordering information, and therefore, there is a possibility that the cost of the consumable cartridge is raised and at the same time, there is a possibility that the processing on the side of the image processing apparatus becomes complicated. On the other hand, in the present embodiment, the management server 102 manages the consumable item information, and therefore, it is not necessary to provide a complicated mechanism to the consumable cartridge and the like, and therefore, such a problem does not arise. (Second embodiment)

The configurations of the consumable item ordering system, the MFP, and the management server in a second embodiment are the same as those of the first embodiment, and therefore, explanation is omitted. Further, the processing of the MFP to transmit consumable item information to the management server is the same as the processing of the first embodiment shown in FIG. 5, and therefore, explanation is omitted. It is not necessary for the management server 102 in the present embodiment to have the status information storage unit 405 shown in FIG. 4A.

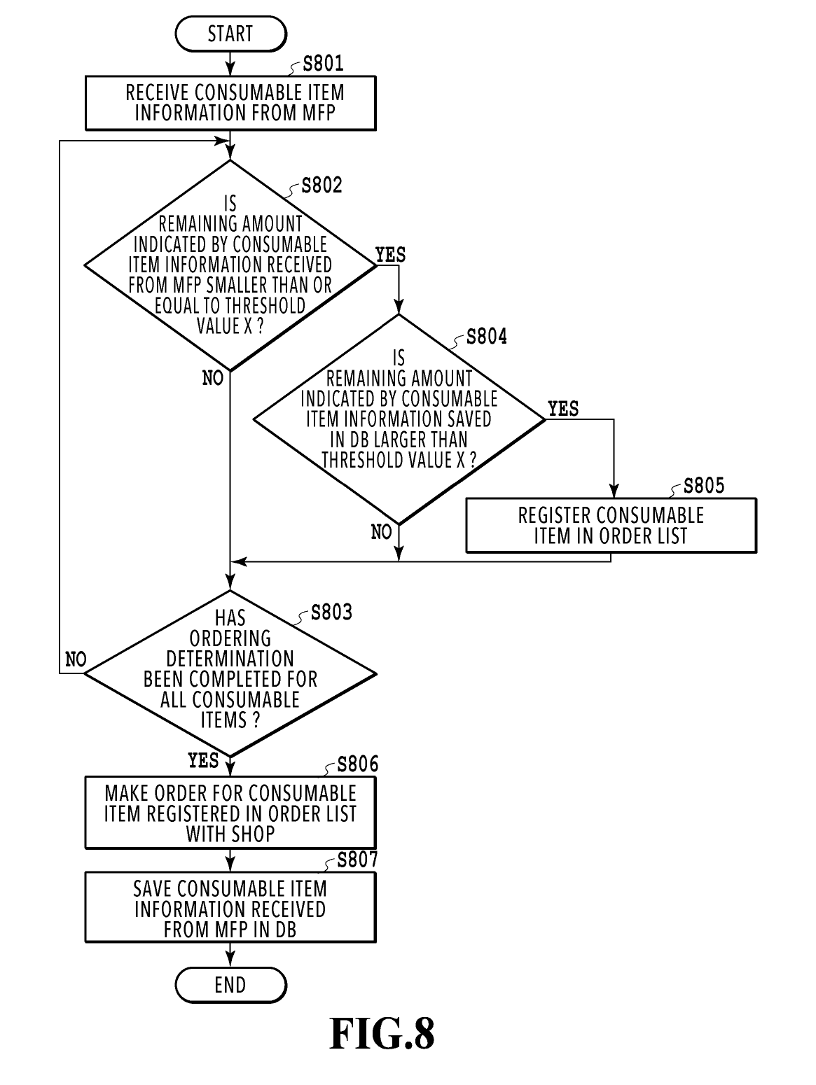

FIG. 8 is a flowchart showing a flow of processing in the second embodiment at the time of the management server 102 making an order for a consumable item with a shop based on the consumable item information received from the MFP 101.

The consumable item information reception unit 401 receives consumable item information from the MFP 101 (step S801). Then, the ordering determination unit 402 checks whether the remaining amount of a consumable item indicated by the received consumable item information is smaller than or equal to the threshold value X. In the case where the remaining amount of the consumable item is not smaller than or equal to the threshold value X (NO at step S802), the processing advances to step S803. In the case where the remaining amount of the consumable item is smaller than or equal to the threshold value X (YES at step S802), the processing advances to step S804.

At step S804, the ordering determination unit 402 refers to the consumable item information received the previous time, which is stored in the database 313 (specifically, the consumable item information storage unit 404). Then, the ordering determination unit 402 checks whether the remaining amount of the consumable item indicated by the consumable item information received the previous time is larger than the threshold value X. In the case where the remaining amount is larger than the threshold value X (YES at step S804), the ordering determination unit 402 registers the consumable item in the order list (step S805) and advances to the processing at step S803. In the case where the remaining amount is smaller than or equal to the threshold value X (NO at step S804), the ordering determination unit 402 advances to the processing at step S803 without performing the processing at step S805 so as to skip the order for the consumable item.

At step S803, the ordering determination unit 402 checks whether the ordering determination has been performed for all the consumable items included in the consumable item information and in the case where there is an unprocessed consumable item, the processing returns to the processing at step S802. In this manner, the ordering determination at steps S802 to S805 is performed for each consumable item.

At step S806, the ordering unit 403 makes an order for the consumable item registered in the order list with a shop. At this time, in the case where no consumable item is registered in the order list, an order by the management server 102 is not made.

At step S807, the consumable item information reception unit 401 stores the consumable item information received at step S801 in the database 313 (specifically, the consumable item information storage unit 404).

As above, in the present embodiment, only in the case where the remaining amount of a consumable item becomes smaller than the threshold value X for the first time, the management server 102 makes an order for the consumable item. Consequently, it is possible to prevent an order from being made doubly in the case where the remaining amount of the consumable item further decreases before the ordered consumable item is attached to the MFP. For example, in the case where the consumable item is an ink tank, it is possible to prevent an order for the same color ink tank from being made during the period of time from the remaining amount of the ink tank becoming smaller than the threshold value X and an order for the ink tank being made until a new ink tank is attached.

It may also be possible to combine the first embodiment with the second embodiment. For example, in the case where a user temporarily removes a consumable cartridge whose remaining amount has become smaller than or equal to the threshold value X from the MFP and the user attaches the removed consumable cartridge to the MFP again after shaking the consumable cartridge, there is a possibility that a remaining amount that exceeds the threshold value X is detected temporarily for the consumable item. In the case where printing is continued in such a state and the remaining amount of the consumable item becomes smaller than the threshold value X again, there is a possibility that an order for the consumable item is made doubly. Consequently, it may also be possible to prevent the above-described double order by combining the processing (steps S801 to S807) of the second embodiment and the processing (steps 604 and S607) of the first embodiment, in which an order for a consumable item is made while checking the ordering status of the consumable item. In order to implement such an aspect, for example, it is sufficient to perform step S604 in the case where YES is determined at step S802 and to advance the processing to step S804 in the case where YES is determined at step S604.

Further, in the first embodiment, in the case where there is a change in the remaining amount of a consumable item attached to the image processing apparatus during the period of time from the consumable item being sent from a shop until the consumable item that is sent being attached to the image processing apparatus, there is a possibility that a double order is made. However, by combining the first embodiment and the second embodiment as described above, it is made possible to prevent also the double order during the period of time described above, which may occur in the first embodiment.

### Third Embodiment

The configuration of the consumable item ordering system in a third embodiment is the same as that of the first embodiment. However, the management server 102 in the present embodiment has a user ordering request reception unit (not shown schematically) configured to receive a user ordering request, to be described later, in addition to the consumable item information reception unit 401, the ordering determination unit 402, and the ordering unit 403 shown in FIG. 4A. Further, the management server 102 in the present embodiment has an ordering history storage unit (not shown schematically) configured to store an execution history of a user ordering request (hereinafter, called an ordering history) in place of the status information storage unit 405. Upon receipt of a user ordering request, the user ordering request reception unit instructs the ordering unit 403 to make an order for a consumable item and stores an ordering history in the ordering history storage unit. The processing of the MFP to transmit consumable item information to the management server is the same as the processing of the first embodiment shown in FIG. 5, and therefore, explanation is omitted.

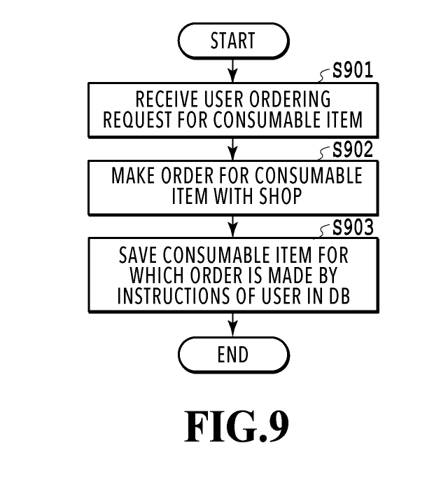

FIG. 9 is a flowchart showing a flow at the time of the management server 102 receiving a user ordering request for a consumable item from a user in the third embodiment. Here, the user ordering request for a consumable item is a request to cause the management server 102 to make an order for a consumable item without waiting for ordering based on the consumable item information received from the MFP 101.

In the case where the user ordering request reception unit receives a user ordering request for a consumable item (step S901), the ordering unit 403 makes an order for the consumable item specified by the user ordering request with a shop (step S902). The user ordering request is issued from the MFP 101 to the management server 102 by a user operating the MFP 101. It may also be possible for a user to issue a user ordering request by using a PC or a smart device without using the MFP 101. That is, an aspect in which a user ordering request is issued from a PC or a smart device is also included in the present embodiment.

The user ordering request reception unit saves an ordering history in the database 313 (specifically, the ordering history storage unit) (step S903). Here, the ordering history is saved in the database 313 for each consumable item.

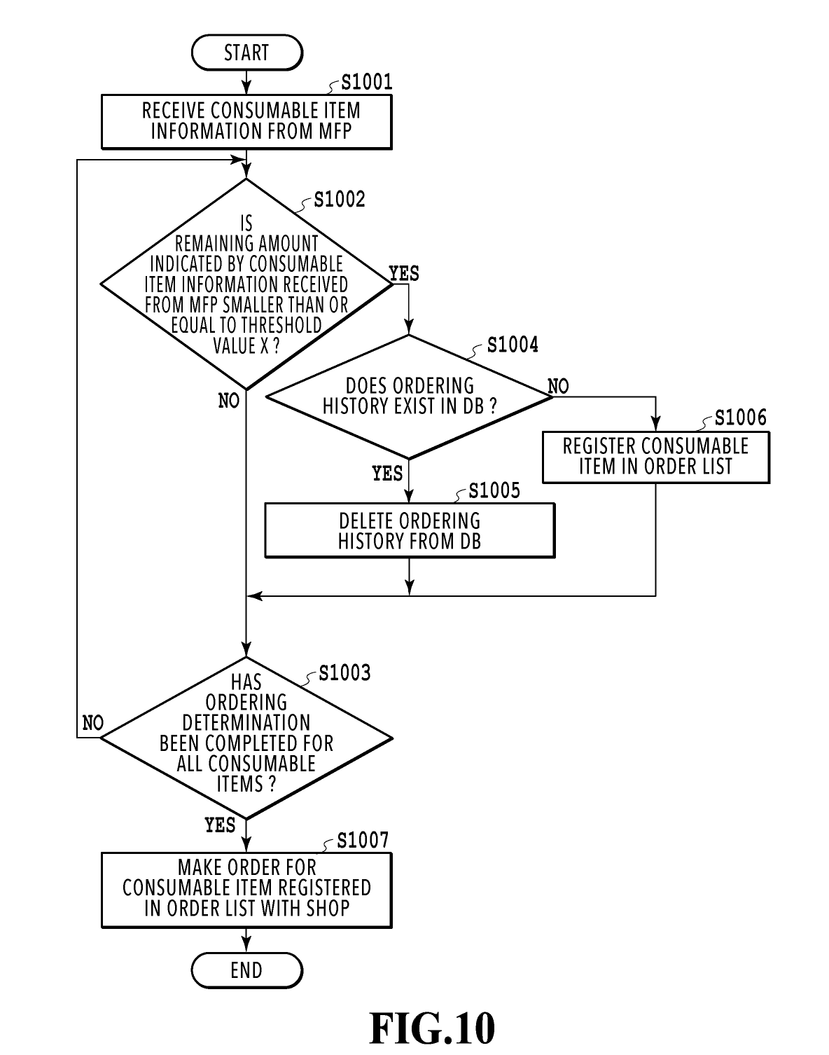

FIG. 10 is a flowchart showing a flow of processing in the third embodiment at the time of the management server 102 making an order for a consumable item with a shop based on the consumable item information received from the MFP 101. The processing at steps S1001, S1002, S1003, and S1007 is the same as the processing at steps S601, S602, S603, and S606, and therefore, explanation is omitted.

At step S1004, the ordering determination unit 402 checks whether the ordering history of the consumable item exists in the database 313 (specifically, the ordering history storage unit). In the case where the ordering history does not exist (NO at step S1004), the ordering determination unit 402 registers the consumable item in the order list (step S1006) and advances to the processing at step S1003. In the case where the ordering history exists (YES at step S1004), the ordering determination unit 402 deletes the ordering history of the consumable item from the database 313 (step S1005). Then, the ordering determination unit 402 advances to the processing at step S1003 without performing the processing at step S1006 so as to skip the order for the consumable item.

As above, in the present embodiment, even in the case where the remaining amount of a consumable item is smaller than the threshold value X, on a condition that the ordering history of the consumable item exists in the database 313, the management server 102 does not make an order for the consumable item. Due to this, in the case where a user intentionally requests an order, the order is made as requested and further, in accordance with whether or not the history of the order made intentionally exists, the order at the timing at which the remaining amount of the consumable item becomes small is skipped. Consequently, according to the present embodiment, even in the case where a user intentionally requests an order, it is possible to suppress a double order for the consumable item not intended by the user.

It may also be possible to manage the number of times the order is made by a user ordering request and to skip the order at the timing at which the remaining amount of a consumable item becomes small in accordance with the number of times. In order to implement such an aspect, for example, it is sufficient for the user ordering request reception unit to save the number of times the order is made by a user ordering request in the database 313 as an ordering history. Then, each time step S1005 is performed, the ordering determination unit 402 decrements (that is, subtracts one from) the above-described number of times the order is made stored in the database 313. Further, in the case where the above-described number of times the order is made becomes 0 at this time, it is sufficient for the ordering determination unit 402 to delete the ordering history from the database 313.

### Fourth Embodiment

The configuration of the consumable item ordering system in a fourth embodiment is the same as that of the first embodiment. However, the management server 102 in the present embodiment has a consumable item already purchased notification reception unit (not shown schematically) configured to receive a consumable item already purchased notification, in addition to the consumable item information reception unit 401, the ordering determination unit 402, and the ordering unit 403 shown in FIG. 4A. The consumable item already purchased notification is a notification to notify that a user has purchased the consumable item and also notify the number of consumable items purchased by a user. Further, the management server 102 in the present embodiment has a number of purchased consumable items storage unit (not shown schematically) configured to store the number of purchased consumable items notified by the consumable item already purchased notification, in place of the status information storage unit 405. The processing of the MFP to transmit consumable item information to the management server 102 is the same as the processing of the first embodiment shown in FIG. 5, and therefore, explanation is omitted.

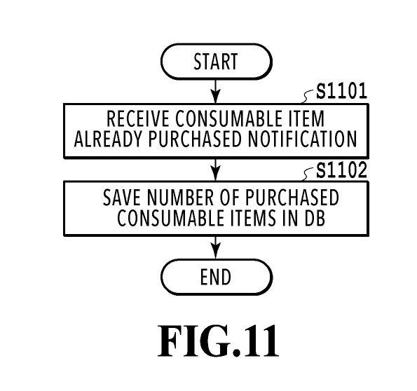

FIG. 11 is a flowchart showing a flow of processing at the time of the management server 102 receiving a consumable item already purchased notification from a user.

The consumable item already purchased notification reception unit receives a consumable item already purchased notification (step S1101). Then, the consumable item already purchased notification reception unit saves the number of purchased consumable items indicated by the consumable item already purchased notification in the database 313 (specifically, the number of purchased consumable items storage unit) for each consumable item as consumable item already purchased information (step S1102). The consumable item already purchased notification is issued to the management server 102 from the MFP 101 by a user operating the MFP 101. It may also be possible for a user to issue a consumable item already purchased notification by using a PC or a smart device without using the MFP 101. Further, it may also be possible for a terminal of a shop to issue a consumable item already purchased notification to the management server 102 in the case where a user purchases the consumable item at the shop. That is, an aspect in which a consumable item already purchased notification is issued from a PC, a smart device, or a terminal of a shop is also included in the present embodiment.

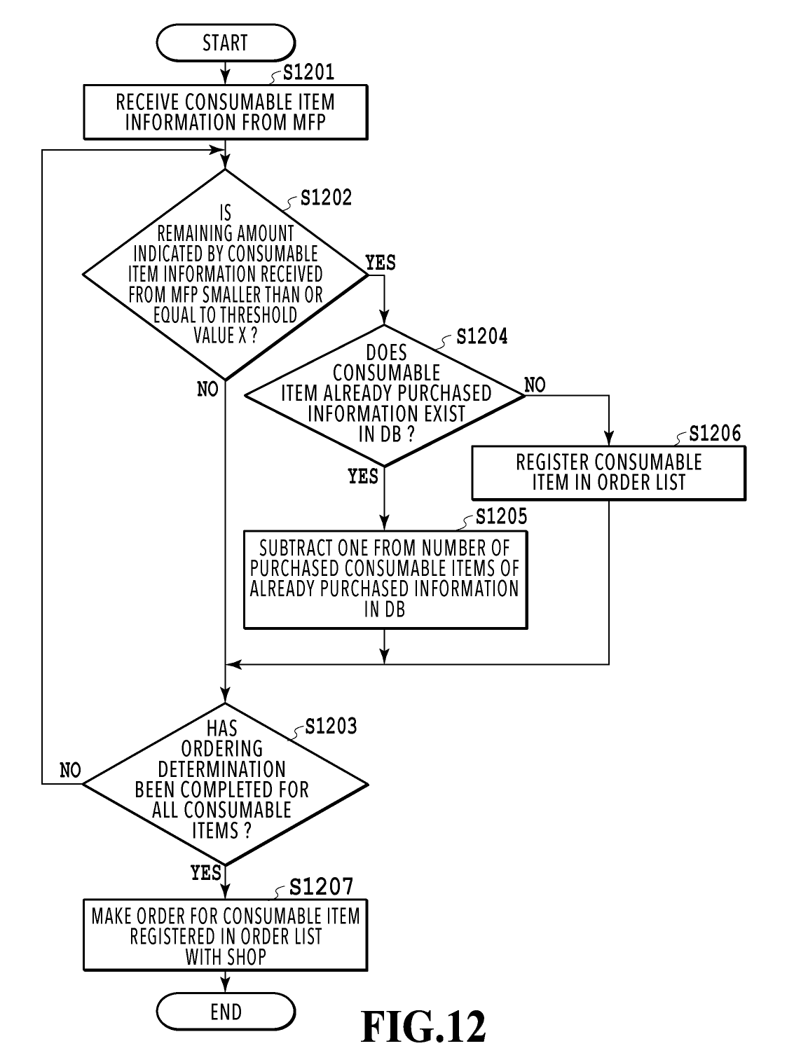

FIG. 12 is a flowchart showing a flow of processing of the fourth embodiment at the time of the management server 102 making an order for a consumable item with a shop based on the consumable item information received from the MFP 101. The processing at steps S1201, S1202, S1203, and S1207 is the same as the processing at steps S601, S602, S603, and S606, and therefore, explanation is omitted.

At step S1204, the ordering determination unit 402 checks whether consumable item already purchased information exists in the database 313 (specifically, the number of purchased consumable items storage unit). In the case where consumable item already purchased information does not exist (NO at step S1204), the ordering determination unit 402 registers the consumable item in the order list (step S1206) and advances to the processing at step S1203. In the case where consumable item already purchased information exists (YES at step S1204), the ordering determination unit 402 decrements (that is, subtracts one from) the number of purchased consumable items indicated by the consumable item already purchased information. At this time, in the case where the number of purchased consumable items indicated by the consumable item already purchased information becomes 0, the ordering determination unit 402 deletes the consumable item already purchased information from the database 313. Then, the ordering determination unit 402 advances to the processing at S1203 without performing the processing at step S1206 so as to skip the order for the consumable item.

As above, in the present embodiment, at the time of a user purchasing a consumable item directly at a shop and the like without interposition of a consumable item ordering system, the management server 102 is notified of the contents (in the present embodiment, the number of consumable items) of the purchased consumable item. Then, the management server 102 stores the consumable item already purchased information in the database 313 in response to the notification from a user. The management server 102 does not make an order for the consumable item in the case where the consumable item already purchased information exists in the database 313, even though the remaining amount of the consumable item is smaller than the threshold value X. Consequently, according to the present embodiment, it is possible to skip the order at the timing at which the remaining amount of a consumable item becomes small in accordance with the number of times corresponding to the number of consumable items purchased directly at a shop and the like by a user. For example, in the case where printing of a large number of sheets, which is not performed normally, is performed, there is a case where a user him/herself prepares a consumable item in advance without awaiting for automatic ordering by the system. In the case such as this, the next automatic ordering is no longer necessary for the user. However, according to the present embodiment, even in the case where a user him/herself has already purchased a consumable item, it is possible to prevent a double order not intended by the user.

### Other Embodiments

As above, the embodiments of the present invention are described in detail, but a variety of other embodiments of the present invention are considered. For example, it may also be possible to combine each of the above-described embodiments.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

According to the present embodiment, in a consumable item ordering system, it is possible to suppress an order for a consumable item not intended by a user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-029400, filed Feb. 20, 2017, which is hereby incorporated by reference wherein in its entirety.

What is claimed is:

1. An information processing apparatus comprising:
a reception unit configured to receive consumable item information indicating a remaining amount of a consumable item attached to an image processing apparatus; and
an ordering unit configured to make an order for the consumable item on a condition that the remaining amount of the consumable item indicated by the consumable item information received by the reception unit is smaller than or equal to a predetermined threshold value, wherein
the ordering unit does not make an order for the consumable item in a case where another condition in relation to second consumable item information received by the reception unit prior to first consumable item information is satisfied, even though the remaining amount of the consumable item indicated by the first consumable item information received by the reception unit is smaller than or equal to the predetermined threshold value.

2. The information processing apparatus according to claim 1, wherein
the ordering unit does not make an order for the consumable item by regarding the other condition as having been satisfied in a case where an order for the consumable item made the previous time based on the second consumable item information is not completed.

3. The information processing apparatus according to claim 2, further comprising:
a storage unit configured to store status information indicating an ordering situation of the consumable item, wherein
the ordering unit:
updates the status information to ordering in progress in a case where an order for the consumable item is made;
updates the status information to ordering completed in a case where a notification of response to the order is received; and
does not make an order for the consumable item in a case where the ordering situation of the consumable item based on the second consumable item information, which is indicated by the status information, is ordering in progress.

4. The information processing apparatus according to claim 1, wherein
the ordering unit does not make an order for the consumable item in a case where the remaining amount of the consumable item indicated by the second consumable item information received by the reception unit the previous time is smaller than or equal to the predetermined threshold value, even though the remaining amount of the consumable item indicated by the first consumable item information received by the reception unit is smaller than or equal to the predetermined threshold value.

5. An information processing apparatus comprising:
a reception unit configured to receive consumable item information indicating a remaining amount of a consumable item attached to an image processing apparatus;
an ordering unit configured to make an order for the consumable item on a condition that the remaining amount of the consumable item indicated by the consumable item information received by the reception unit is smaller than or equal to a predetermined threshold value; and
a storage unit configured to store information in relation to a purchase of the consumable item by a user, wherein
the ordering unit does not make an order for the consumable item in a case where information stored in the storage unit satisfies another condition, even though the remaining amount of the consumable item indicated by the consumable item information received by the reception unit is smaller than or equal to the predetermined threshold value.

6. The information processing apparatus according to claim 5, wherein
the storage unit stores an execution history indicating that an order for the consumable item has been made by a user request to cause the ordering unit to make an order for the consumable item in response to instructions of a user, and
the ordering unit does not make an order for the consumable item in a case where the other condition in relation to an execution history stored in the storage unit is satisfied.

7. The information processing apparatus according to claim 6, wherein
the ordering unit:
deletes, in a case where an order for the consumable item is not made because an execution history is stored, the execution history of the user request from the storage unit; and
does not make an order for the consumable item by regarding the other condition as having been satisfied in a case where the execution history is stored in the storage unit.

8. The information processing apparatus according to claim 5, wherein
the storage unit stores a number of consumable items purchased by a user, and
the ordering unit does not make an order for the consumable item in a case where the number of purchased consumable items stored in the storage unit is larger than 0, even though the remaining amount of the consumable item indicated by the consumable item information received by the reception unit is smaller than or equal to the predetermined threshold value.

9. The information processing apparatus according to claim 8, wherein
the ordering unit decrements the number of purchased consumable items stored in the storage unit in a case where an order for the consumable item is not made because the number of purchased consumable items is larger than 0.

10. The information processing apparatus according to claim 8, further comprising:
a reception unit configured to receive an already purchased notification notifying that the consumable item has been purchased by a user and the number of purchased consumable items, wherein
the reception unit stores the number of purchased consumable items notified by the already purchased notification in the storage unit.

11. The information processing apparatus according to claim 1, wherein
the consumable item information indicates a remaining amount of one or each of a plurality of consumable items attached to the image processing apparatus, and
the ordering unit determines whether or not to make an order for the one or each of the plurality of consumable items and in accordance with results of the determination, makes an order for the one or at least one of the plurality of consumable items.

12. The information processing apparatus according to claim 1, wherein
the image processing apparatus is a printer and the consumable item is ink or toner.

13. A consumable item ordering system comprising an image processing apparatus and an information processing apparatus, wherein
the information processing apparatus has:
a reception unit configured to receive consumable item information indicating a remaining amount of a consumable item attached to the image processing apparatus; and
an ordering unit configured to make an order for the consumable item on a condition that the remaining amount of the consumable item indicated by the consumable item information received by the reception unit is smaller than or equal to a predetermined threshold value, and
the ordering unit does not make an order for the consumable item in a case where another condition in relation to second consumable item information received by the reception unit prior to first consumable item information is satisfied, even though the remaining amount of the consumable item indicated by the first consumable item information received by the reception unit is smaller than or equal to the predetermined threshold value.

14. The consumable item ordering system according to claim 13, wherein
the ordering unit does not make an order for the consumable item by regarding the other condition as having been satisfied in a case where an order for the consumable item made the previous time based on the second consumable item information is not completed.

15. The consumable item ordering system according to claim 14, further comprising:
a storage unit configured to store status information indicating an ordering situation of the consumable item, wherein
the ordering unit:
updates the status information to ordering in progress in a case where an order for the consumable item is made;
updates the status information to ordering completed in a case where a notification of response to the order is received; and
does not make an order for the consumable item in a case where the ordering situation of the consumable item based on the second consumable item information, which is indicated by the status information, is ordering in progress.

16. The consumable item ordering system according to claim 13, wherein
the ordering unit does not make an order for the consumable item in a case where the remaining amount of the consumable item indicated by the second consumable item information received by the reception unit the previous time is smaller than or equal to the predetermined threshold value, even though the remaining amount of the consumable item indicated by the first consumable item information received by the reception unit is smaller than or equal to the predetermined threshold value.

17. The consumable item ordering system according to claim 13, wherein
the consumable item information indicates a remaining amount of one or each of a plurality of consumable items attached to the image processing apparatus, and
the ordering unit determines whether or not to make an order for the one or each of the plurality of consumable items and in accordance with results of the determination, makes an order for the one or at least one of the plurality of consumable items.

18. The consumable item ordering system according to claim 13, wherein
the image processing apparatus is a printer and the consumable item is ink or toner.

19. An information processing method in a system comprising an image processing apparatus and an information processing apparatus, wherein
the image processing apparatus performs a transmission step of transmitting consumable item information indicating a remaining amount of a consumable item attached to the image processing apparatus,
the information processing apparatus performs an ordering step of making an order for the consumable item on a condition that the remaining amount of the consumable item indicated by the consumable item information transmitted at the transmission step is smaller than or equal to a predetermined threshold value, and
the information processing apparatus does not make an order for the consumable item in a case where another condition in relation to second consumable item information transmitted at the transmission step prior to first consumable item information is satisfied, even though the remaining amount of the consumable item indicated by the first consumable item information transmitted at the transmission step is smaller than or equal to the predetermined threshold value.
